(19) United States
(12) Patent Application Publication
(10) Pub. No.: US 2010/0330411 A1
(43) Pub. Date: Dec. 30, 2010

(54) THIN FILM BATTERY AND METHOD OF CONNECTING ELECTRODE TERMINAL OF THIN FILM BATTERY

(76) Inventors: Sang Cheol NAM, Seoul (KR); Ho Young Park, Seoul (KR); Young Chang Lim, Seoul (KR); Ki Chang Lee, Seoul (KR); Young Kyun Jung, Seoul (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/824,564

(22) Filed: Jun. 28, 2010

(30) Foreign Application Priority Data
Jun. 30, 2009 (KR) 10-2009-0058990

(51) Int. Cl. H01M 10/28; H01M 4/00; H01M 10/26

(52) U.S. Cl. 429/156; 429/211; 429/206; 29/623.1

(57) ABSTRACT

Provided is a thin film battery, including: a base substrate; a cathode current collector pattern and an anode current collector pattern being formed on the base substrate and being electrically separate from each other; a cathode terminal and an anode terminal being directly bonded with the cathode current collector pattern and the anode current collector pattern; a cathode and an anode being disposed on the cathode current collector pattern and the anode current collector pattern; and an electrolyte layer being disposed between the cathode and the anode.

### CROSS-REFERENCE TO RELATED APPLICATION

This application claims the benefit under 35 U.S.C. §119 of Korean Patent Application No. 10-2009-0058990, filed on Jun. 30, 2009, which is hereby incorporated by reference in its entirety.

### BACKGROUND

1. Field of the Invention

The present invention relates to a battery, and more particularly, to a thin film battery and a method of connecting electrode terminals of the thin film battery.

2. Description of the Related Art

In the case of a general bulk-type lithium battery, that is, a lithium ion battery or a lithium polymer battery, an electrode tap connection may use welding between an aluminum tap and an aluminum foil with respect to a cathode and may use ultrasonic or rivet welding between a nickel tap and a copper foil with respect to an anode. Through this, electrode terminals may be formed.

However, in the case of a thin film battery, a cathode current collector pattern and an anode current collector pattern are formed in a thin film having a thickness measured in thousands of Å. Thus, it is difficult to connect the cathode current collector pattern and the anode current collector pattern to an external device.

In the thin film battery developed to date, a conventional method of connecting an electrode terminal to an external device may use soldering, a conductive tape, a conductive paste, and the like.

However, the above schemes may cause damage to the thin film battery due to an external impact, coming-off of an under-layer, and a thermal transfer, and may also need to continuously maintain a predetermined pressure.

### BRIEF SUMMARY

An aspect of the present invention provides a thin film battery in which a bonding force between electrodes terminals may be enhanced and a thermal damage due to bonding may be reduced.

Another aspect of the present invention also provides a method of connecting electrode terminals of a thin film battery that may increase a bonding force, and may reduce a thermal damage to a thin film battery when connecting electrode terminals of the thin film battery.

According to an aspect of the present invention, there is provided a thin film battery, including: a base substrate; a cathode current collector pattern and an anode current collector pattern being formed on the base substrate and being electrically separate from each other; a cathode terminal and an anode terminal being directly bonded with the cathode current collector pattern and the anode current collector pattern; a cathode and an anode being disposed on the cathode current collector pattern and the anode current collector pattern; and an electrolyte layer being disposed between the cathode and the anode.

According to another aspect of the present invention, there is provided a thin film battery, including: a laminated body in which a plurality of unit cells are disposed in parallel, and each of the unit cells includes a base substrate a cathode current collector pattern and an anode current collector pattern being formed on the base substrate and being electrically separate from each other, a first cathode terminal and a first anode terminal being directly bonded with the cathode current collector pattern and the anode current collector pattern, a cathode and an anode being disposed on the cathode current collector pattern and the anode current collector pattern, and an electrolyte layer being disposed between the cathode and the anode; and a sealing member sealing the laminated body.

According to still another aspect of the present invention, there is provided a method of directly bonding a cathode terminal and an anode terminal to a cathode current collector pattern and an anode current collector pattern of a thin film battery, respectively, without using a separate medium.

Other features and aspects will be apparent from the following detailed description, the drawings, and the claims.

According to embodiments of the present invention, it is possible to simply connect electrode terminals of a thin film battery to have a high bonding force. Also, when connecting the electrode terminals, although a thermal process may be omitted or not be omitted, heat may be locally transferred to the thin film battery. Accordingly, it is possible to prevent or reduce a thermal damage to the thin film battery.

### BRIEF DESCRIPTION OF THE DRAWINGS

The file of this patent contains at least one drawing executed in color. Copies of this patent with color drawings will be provided by the Patent and Trademark Office upon request and payment of the necessary fee.

These and/or other aspects, features, and advantages of the invention will become apparent and more readily appreciated from the following description of exemplary embodiments, taken in conjunction with the accompanying drawings of which:

FIG. 1 is a cross-sectional view of a thin film battery in which electrode terminals are connected according to an embodiment of the present invention;

FIG. 2 is a cross-sectional view of a thin film battery in which each electrode terminal is connected to a laminated body where a plurality of unit cells are disposed in a thin film battery according to an embodiment of the present invention;

FIG. 3 is a cross-sectional view to describe a thin film battery according to an embodiment of the present invention;

FIG. 4 is a photo showing an electrode terminal bonded on an anode current collector pattern according to an embodiment of the present invention; and

FIG. 5 is a graph comparing a discharge amount of a thin film battery according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

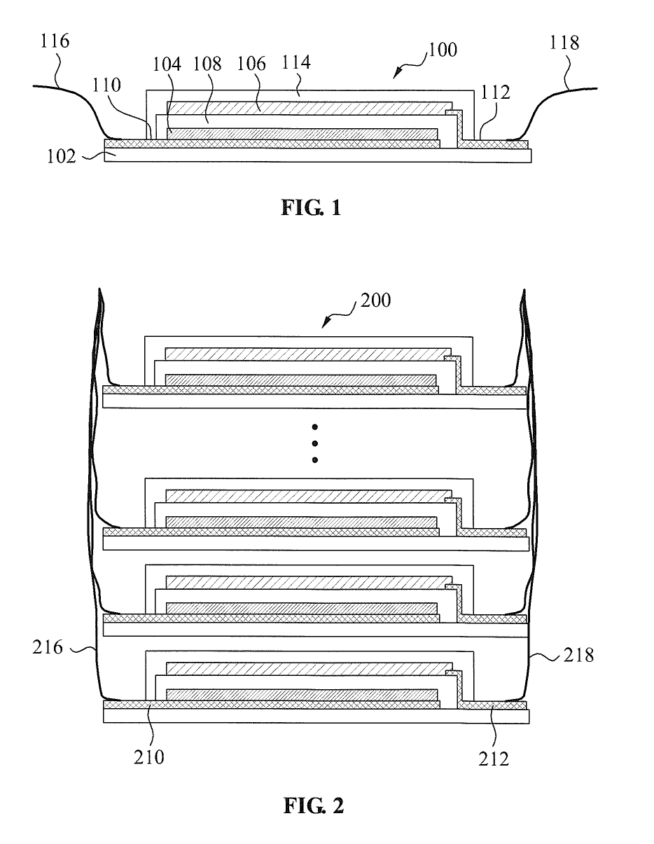

FIG. 1 is a cross-sectional view of a thin film battery 100 in which electrode terminals are connected according to an embodiment of the present invention. In FIG. 1, a lithium battery is used as the thin film battery 100. However, it is only an example and thus the present invention is not limited thereto. For example, the present invention may be applicable to a thin film battery such as a solar battery and to other various types of thin film batteries having an electrode terminal.

Referring to FIG. 1, the thin film battery 100 may include a single unit cell, a cathode terminal 116, and an anode terminal 118. The thin film battery 100 may also be configured in a plurality of laminated-type thin film battery.

The unit cell may include a cathode 104, an anode 106, an electrolyte layer 108, a cathode current collector pattern 110, and an anode current collector pattern 112 that are formed on a base substrate 102. The unit cell may further include a protecting film 114. The unit cell may further include a metal-containing layer (not shown) being disposed between the base substrate 102 and each of the cathode current collector pattern 110 and the anode current collector pattern 112, to thereby enhance an adhesive property between the base substrate 102 and each of the cathode current collector pattern 110 and the anode current collector pattern 112.

The base substrate 102 may use any one of a metal sheet made of a metal such as nickel (Ni), titanium (Ti), chrome (Cr), stainless steel, tungsten (W), molybdenum (M), and the like; a ceramic or glass sheet made of a substance such as aluminum oxide (Al₂O₃), zirconium oxide (ZrO₂), silicon dioxide (SiO₂), quartz, glass, mica, and the like; and a polymer sheet made of a polymer such as polytetrafluoroethylene, polyimide, polyamide imide, polysulfone, polyphenylene sulfide, polyetherether ketone, polyether ketone, and the like. The above mica may include both natural mica and synthetic mica. Also, the base substrate 102 may use a silicon wafer, an oxide processed substrate on the silicon wafer, and the like.

When the base substrate 102 has a thickness of tens of μm, a conductive material, a binder, and the like may not be used for a cathode active material. Accordingly, a high energy density configuration may be enabled. When the base substrate 102 has a thickness of within a few μn, a total thickness of the thin film battery 100 may be controlled to be within 20 μm, and a capacity of the unit cell of the thin film battery 100 may increase by disposing a plurality of unit cells. Accordingly, the thin film battery 100 may be used as a power supply source of a smart card, a variety of tag products and Microelectromechanical Systems (MEMS), and an ultra-slim electronic device.

The cathode 104 may use any cathode known in the art and is not particularly restricted. An active material may be used for the cathode 104. A cathode active material may be a compound enabling reversible intercalation/de-intercalation of lithium in a lithium battery and may use one of or a combination of at least two of LiCoO₂, LiMn₂O₄, LiNiO₂, LiFePO₄, LiNiVO₄, LiCoMnO₄, LiCO_{1/3}Ni_{1/3}Mn_{1/3}O₂, V₂O₅, MnO₂, MoO₃, and the like.

The anode 106 may also use any anode known in this art and is not particularly restricted. An active material may be used for the anode 106. An anode active material may be a compound enabling reversible oxidation-reduction of lithium in a lithium battery and may use one of or a combination of at least two of Li, Sn₃N₄, Si, graphite, Li-Me alloys, and the like.

The electrolyte layer 108 may be disposed between the cathode 104 and the anode 106, and may use an inorganic solid electrolyte or an organic solid electrolyte. Examples of the inorganic solid electrolyte may include Li₂O—B₂O₃, Li₂O—V₂O₅—SiO₂, Li₂SO₄—Li₂O—B₂O₃, Li₃PO₄, Li₂O—Li₂WO₄—B₂O₃, LiPON, LiBON, and the like. One of or a combination of at least two thereof may be used. Examples of the organic solid electrolyte may include the mixture of lithium salt with respect to polyethylene derivatives, polyethylene oxide derivatives, polypropylene oxide derivatives, phosphoric ester polymer, a poly agitation lysine, polyester sulfide, polyvinyl alcohol, poly fluoride vinylidene, and the like. One of or a combination of at least two thereof may be used.

The cathode current collector pattern 110 may be electrically connected to the cathode 104. When a material of the cathode current collector pattern 110 has a high conductivity without causing a chemical change in the thin film battery 100, the material of the cathode current collector pattern 110 is not particularly restricted. For example, the cathode current collector pattern 110 may use a precious metal such as platinum (Pt), gold (Au), and the like, a heat resisting steel such as nickel-containing alloys and the like, a conductive oxide film such as indium tin oxide (ITO), and the like.

The nickel-containing alloys may include hastelloy, inconel, and the like that may be commercially obtained. By depositing titanium and metal oxide such as titanium oxide, and the like, that is a diffusion protecting film, prior to forming the cathode current collector pattern 110, it is possible to increase an adhesive property of the cathode active material. Various forms such as a film, a sheet, a foil, a net, a porous body, a foam body, a non-woven fabric body, and the like may be employed.

The anode current collector pattern 112 may be electrically connected to the anode 106, and may also be electrically separate from the cathode current collector pattern 110. When a material of the anode current collector pattern 112 has a conductivity without causing an electrical change in the thin film battery 100, the material of the anode current collector pattern 112 is not particularly restricted. For example, the anode current collector pattern 112 may use a precious metal such as Pt, Au, and the like, a heat resisting steel containing nickel or copper such as hastelloy, inconel, and the like, a conductive oxide film such as ITO, and the like. It is possible to increase an adhesive property of the anode active material by forming a minute unevenness on the anode current collector pattern 112 as necessary. In this instance, various forms such as a film, a sheet, a foil, a net, a porous body, a foam body, a non-woven fabric body, and the like may be employed.

The protecting film 114 is to prevent the thin film battery 100 from being oxidized in the air. The protecting film 114 may include an organic protecting film, an inorganic protecting layer, or a combination of the organic protecting film and the inorganic protecting film.

A material of the organic protecting film is not particularly restricted, and may use one of or a combination of at least two of diazo-based resin, azide-based resin, acrylic-based resin, polyamide-based resin, polyester-based resin, epoxide-based resin, polyether-base resin, urethane-based resin, and the like where polymerization is initiated by photo polymerization. A material of the organic protecting film may use one of or a combination of at least two of polystyrene-based resin, acrylic-based resin, urea-based resin, isocyanate-based resin, xylene-base resin, and the like where a radical is generated by heat and thereby polymerization is initiated. The above resin where the polymerization is initiated by the photo polymerization, the above resin where the radical is generated by head and thereby the polymerization is initiated, and the like may be combined and thereby be used.

A material of the inorganic protecting film is not particularly restricted, and may use one of or a combination of at least two of silicon nitride, aluminum nitride, zirconium nitride, titanium nitride, hafnium nitride, tantalum nitride, silicon oxide, aluminum oxide, zirconium oxide, magnesium oxide, titanium oxide, tin oxide, cerium oxide, silicon oxide nitride (SiON), and the like.

As an example where the protecting film 114 includes the combination of the organic protecting film and the inorganic protecting film, the organic protecting film and the inorganic protecting film may be alternately provided such as organic protecting film-inorganic protecting film-organic protecting film-inorganic protecting film, or one protecting film may be provided in at least double deck such as organic protecting film-organic protecting film-inorganic protecting film. In this instance, a material of the protecting film 114 constituting each layer may be the same or be different.

A disposition order of each of constituent elements in the unit cell may not be particularly restricted. Specifically, the constituent elements may be disposed on the base substrate 102 in various orders, for example, in an order of the cathode current collector pattern 110, the cathode 104, the electrolyte layer 108, the anode 106, the anode current collector pattern 112, and the protecting film 114; in an order of the cathode current collector pattern 110, the cathode 104, the electrolyte layer 108, the anode current collector pattern 112, the anode 106, and the protecting film 114; in an order of the cathode 104, the cathode current collector pattern 110, the electrolyte layer 108, the anode 106, the anode current collector pattern 112, and the protecting film 114; in an order of the cathode 104, the cathode current collector pattern 110, the electrolyte layer 108, the anode current collector pattern 112, the anode 106, and the protecting film 114; in an order of the anode current collector pattern 112, the anode 106, the electrolyte layer 108, the cathode 104, the cathode current collector pattern 110, and the protecting film 114; in an order of the anode current collector pattern 112, the anode 106, the electrolyte layer 108, the cathode current collector pattern 110, the cathode 104, and the protecting film 114; in an order of the anode 106, the anode current collector pattern 112, the electrolyte layer 108, the cathode 104, the cathode current collector pattern 110, and the protecting film 114; or in an order of the anode 106, the anode current collector pattern 112, the electrolyte layer 108, the cathode current collector pattern 110, the cathode 104, and the protecting film 114.

The unit cell may be manufactured through a dry process, a wet process, or a combined process of the dry process and the wet process. If required, a crystallization process may be induced during the above manufacturing process. Examples of the dry process may include a thermal evaporation scheme, an e-beam evaporation scheme, a sputtering scheme, a vacuum evaporation scheme, and the like. Examples of the wet process may include a spin coating scheme, a sol-gel scheme, a deep coating scheme, a casting scheme, a printing scheme, a spraying scheme, and the like.

The cathode terminal 116 may be electrically connected to the cathode current collector pattern 110, and/or the anode terminal 118 may be electrically connected to the anode current collector pattern 112. The electrical connection may be made by directly bonding the cathode current collector pattern 110 and the anode current collector pattern 112 with the cathode terminal 116 and the anode terminal 118, respectively. Specifically, without using a separate bonding material as a medium, materials of the cathode current collector pattern 110 and the anode current collector pattern 112 may be directly combined with materials of the cathode terminal 116 and the anode terminal 118 in respective corresponding bonding portions. In this instance, a molecular diffusion may be performed in the bonding portions. For this, bonding of the cathode current collector pattern 110 and the cathode terminal 116, and/or bonding of the anode current collector pattern 112 and the anode terminal 118 may be performed through any one of ultrasonic processing, thermosonic processing, and micro-resistance heating processing. Specifically, the cathode current collector pattern 110 and the anode current collector pattern 112 may be bonded with the cathode terminal 116 and the anode terminal 118 by inducing the molecular diffusion or a local heat generation in the bonding portions.

The cathode terminal 116 may be directly connected to the cathode 104, or the anode terminal 118 may be directly connected to the anode 106. Even in this case, the present invention may be applicable.

In the case of ultrasonic processing, due to ultrasonic vibrations, frictions may occur in a boundary surface between an electrode terminal and a current collector pattern, whereby it is possible to bond the electrode terminal and the current collector pattern through diffusion of material molecules.

In the case of thermosonic processing, in addition to ultrasonic vibrations, heat may be locally applied to an electrode terminal and/or a current collector pattern. Through this, it is possible to promote diffusion and migration of each material, and to thereby bond the electrode terminal and the current collector pattern.

In the case of micro-resistance heating processing, it is possible to bond an electrode terminal and a current collector pattern within tens of msec using a heat generated when applying a predetermined voltage to the electrode terminal and the current collector pattern.

As described above, by employing one of ultrasonic processing, thermosonic processing, and micro-resistance heating processing, it is possible to easily connect electrode terminals of a thin film battery to have a high bonding force. When connecting the electrode terminals of the thin film battery, a heat process may be excluded. Even though the heat process is not excluded, the heat may be locally transferred to the thin film battery and thus it is possible to prevent damage of the thin film battery.

FIG. 2 is a cross-sectional view of a thin film battery 200 in which each electrode terminal is connected to a laminated body where a plurality of unit cells are disposed according to an embodiment of the present invention. Here, each unit cell may be configured to be the same as the unit cell described above with reference to FIG. 1 and thus further description will be omitted here.

Referring to FIG. 2, the thin film battery 200 may include a laminated body where a plurality of unit cells is disposed. In each unit cell, a cathode current collector pattern 210 may be connected to a cathode terminal 216, and an anode current collector pattern 212 may be connected to an anode terminal 218. A connection between the cathode current collector pattern 210 and the cathode terminal 216 and/or a connection between the anode current collector pattern 212 and the anode terminal 218 may be performed by one of ultrasonic processing, thermosonic processing, and micro-resistance heating processing. One end of the cathode terminals 216 may be connected to oner end of another cathode. One end of the anode terminals 218 may be connected to one end of another anode.

Hereinafter, a method of manufacturing the thin film battery 200 constructed as above will be described.

Initially, the plurality of unit cells may be prepared. In each unit cell, the cathode terminal 216 may be connected to the cathode current collector pattern 210, and the anode terminal 218 may be connected to the anode current collector pattern 212. A plurality of unit cells, each connected with the cathode terminal 216 and the anode terminal 218, may be disposed. A plurality of cathode terminals 216 may be connected to each other, and a plurality of anode terminals 218 may be connected to each other. Through this, the plurality of cathode terminals 216 may be integrally formed, and the plurality of anode terminals 218 may be integrally formed. A spot welding may be used to connect the plurality of cathode terminals 216 and/or to connect the plurality of anode terminals 218. However, it is only an example and thus the present invention is not limited thereto. Specifically, the above process may be performed by one of ultrasonic processing, thermosonic processing, and micro-resistance heating processing, and may also be performed by other known schemes. When manufacturing the thin film battery 200, a disposition order of constituent elements may be differently configured. For example, after disposing a plurality of unit cells, an electrode terminal may be connected to each unit cell. In addition, a manufacturing process of the thin film battery 200 may be variously modified.

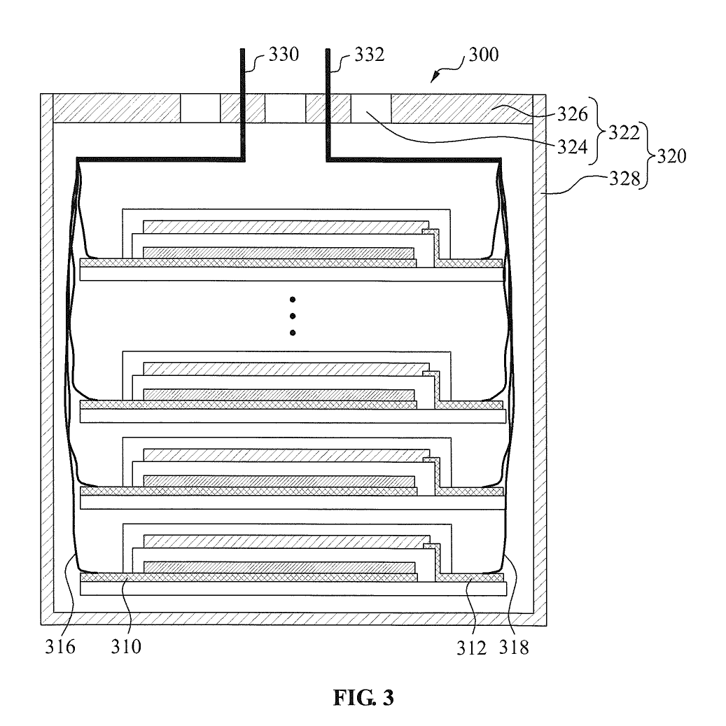

FIG. 3 is a cross-sectional view to describe a thin film battery 300 according to an embodiment of the present invention. FIG. 3 illustrates the thin film battery 300 with a plurality of disposed unit cells, sealed by a sealing member 320. Here, the unit cell, a first cathode terminal 316, and a first anode terminal 318 may be configured to be the same as described above with reference to FIGS. 1 and 2, and thus further detailed description will be omitted.

Referring to FIG. 3, the thin film battery 300 may include the plurality of unit cells, the first cathode terminal 316, the first anode terminal 318, the sealing member 320, a second cathode terminal 330, and a second anode terminal 332.

The sealing member 320 may include a first sealing member 322 and a second sealing member 328 that may be combined with each other and/or be separate from each other. The plurality of unit cells may be sealed by combining the first sealing member 322 and the second sealing member 328.

The first sealing member 322 may include a glass member 324 and a metal member 326. The partially exposed second cathode terminal 330 and the partially exposed second anode terminal 332 may be combined with the first sealing member 322. In this instance, the second cathode terminal 330 may be formed of a single wire, and functions to electrically connect the plurality of first electrode terminals 316 and externally expose the plurality of first electrode terminals 316 from the sealing member 320. The externally exposed second cathode terminal 330 and second anode terminal 332 may be used for connection with an external device.

The second sealing member 328 may seal the disposed inner unit cells in a side portion and a floor portion of the thin film battery 300, and an inner wall of the second sealing member 328 may be insulation-coated. The second sealing member 328 may be formed of a metal and the like, and an inner wall of the second sealing member 328 may be insulation-coated.

Since the thin film battery 300 is sealed by the sealing member 320, the thin film battery 300 may be robust against an external impact. Since moisture penetration is prevented, the thin film battery 300 may have a relatively long lifespan of at least ten years. Hereinafter, a method of manufacturing the thin film battery 300 constructed as above will be described.

As described above with reference to FIG. 2, the plurality of unit cells may be prepared. In each unit cell, the cathode current collector pattern 310 may be connected to the first cathode terminal 316, and the anode current collector pattern 312 may be connected to the first anode terminal 318. The plurality of first cathode terminals 316 may be connected to each other, and the plurality of first anode terminals 318 may be connected to each other.

One end of the integrated first cathode terminal 316 may be connected to the second cathode terminal 330 combined with the first sealing member 322. Further one end of the integrated first anode terminal 318 may be connected to the second anode terminal 332 combined with the first sealing member 322. In this instance, a spot welding may be used for a connection between the integrated first cathode terminal 316 and the second cathode terminal 330 and/or a connection between the integrated first anode terminal 318 and the second anode terminal 332. However, it is only an example and thus the present invention is not limited thereto. Specifically, the above process may be performed by one of ultrasonic processing, thermosonic processing, and micro-resistance heating processing, and may also be performed by another known scheme. The first sealing member 322 and the second sealing member 328 may be combined with the each other using a laser welding. Through the above process, the thin film battery 300 may be completed.

According to an embodiment of the present invention, it is possible to connect a unit cell of a thin film battery and an electrode terminal by one of ultrasonic processing, thermosonic processing, and micro-resistance heating processing. Through this, it is possible to easily connect the thin film battery and the electrode terminal to have a high bonding force, and to prevent damage to the thin film battery occurring due to a heat.

Hereinafter, embodiments of the present invention will be further described. However, technical spirits of the present invention are not limited by the following embodiments.

### Example 1

A mica film having a thickness of 50 μm was used as a base substrate, and Pt was direct current (DC) sputtered to have a thickness of about 300 nm as a cathode current collector pattern. To increase an adhesive property with the base substrate, Ti was deposited between Pt and the base substrate to have a thickness of about 150 nm. LiCoO₂ target was used as a cathode active material and was magnetron sputtered by applying a DC/radio frequency (RF) hybridization power in a thickness of about 3 nm in an atmosphere of about 10 to 20 mTorr of argon/oxygen mixture gas. For crystallization of an anode, a rapid heat-treatment process was performed in a process condition not destroying a vacuum state. A solid electrolyte layer thin film was formed by depositing LiPON electrolyte layer with a thickness of about 1.5 nm, the LiPON electrolyte layer was a form that oxygen within Li₃PO₄ is partially substituted to nitride by using Li₃PO₄ target and by RF magnetron sputtering in a pure nitrogen gas atmosphere. Next, a Cu—Zn alloy thin film having a thickness of about 400 nm was deposited as an anode current collector pattern.

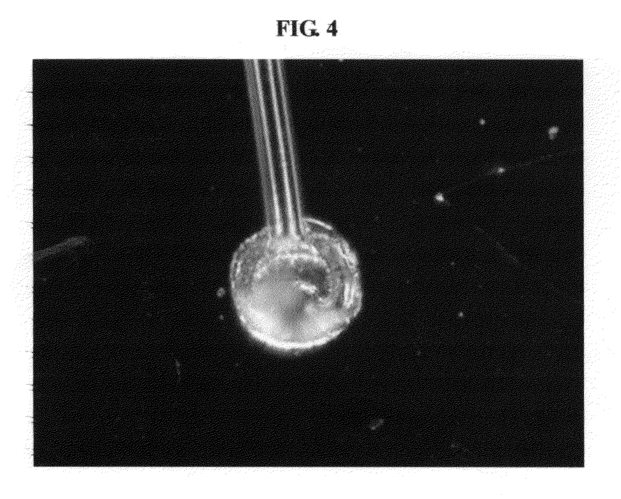

A metal lithium thin film used as an anode was deposited by a thermal evaporation depositing scheme. In this instance, a thickness was about 2 nm. Next, an inorganic protecting film and an organic protecting film were alternately deposited as protecting films whereby the thin film battery including a single unit cell was manufactured. Next, by inserting the thin film battery into a jig appropriate for a size of the thin film battery, electrode terminals having a thickness of about 25 μm, that is, Au wires were bonded to the cathode current collector pattern and the anode current collector pattern in the temperature of 60° C. according to thermosonic processing. The thermosonic processing applied a bonding force of about 26 gf for about 15 msec by employing about 130 W of ultrasonic waves. FIG. 4 illustrates a photo showing a cathode terminal bonded on the cathode current collector pattern. Referring to FIG. 4, the cathode terminal had a bonding force of about 7 to 9 gf.

### Example 2

Seven unit cells, each connected with electrode terminals as same as Example 1, were manufactured. A thin film battery was manufacturing by disposing the seven unit cells. Next, after connecting cathode terminals to each other and connecting anode terminals to each other, each of the connected cathode terminals and the anode terminals was integrated using a spot welding.

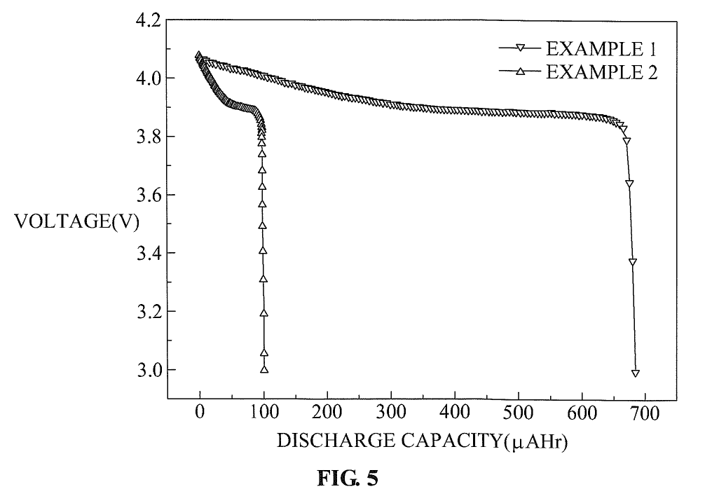

To verify whether the thin film battery connected with each unit cell was appropriately operating, a capacity of the unit cell manufactured according to Example 1 was compared with a capacity of the thin film battery where the seven unit cells were disposed according to Example 2. A result of comparison is shown in FIG. 5.

Referring to FIG. 5, when a discharge was made based on about 1 C rate (100 μA), the capacity of the unit cell manufactured according to Example 1 was on average about 100 μAh. When the discharge was made based on about 1 C rate (700 μA), the capacity of the thin film battery where the seven unit cells were disposed according to Example 2 was about 690 μAh. Accordingly, it can be known from the result that a unit cell connection was effectively performed.

What is claimed is:

1. A thin film battery, comprising:
a base substrate;
a cathode current collector pattern and an anode current collector pattern being formed on the base substrate and being electrically separate from each other;
a cathode terminal and an anode terminal being directly bonded with the cathode current collector pattern and the anode current collector pattern;
a cathode and an anode being disposed on the cathode current collector pattern and the anode current collector pattern; and
an electrolyte layer being disposed between the cathode and the anode.

2. The thin film battery of claim 1, wherein bonding is performed according to at least one of ultrasonic processing, thermosonic processing, and micro-resistance heating processing.

3. The thin film battery of claim 1, wherein each of the cathode terminal and the anode terminal corresponds to a metal wire.

4. The thin film battery of claim 1, wherein the base substrate comprises natural mica or synthetic mica.

5. The thin film battery of claim 1, wherein the base substrate corresponds to a silicon wafer substrate or an oxide processed substrate on the silicon wafer.

6. The thin film battery of claim 1, further comprising:
a metal-containing layer for adhesive property enhancement, being disposed between the base substrate and each of the cathode current collector pattern and the anode current collector pattern.

7. The thin film battery of claim 1, wherein the electrolyte layer comprises at least one compound selected from a group consisting of Li₂O—B₂O₃, Li₂O—V₂O₅—SiO₂, Li₂SO₄—Li₂O—B₂O₃, Li₃PO₄, Li₂O—Li₂WO₄—B₂O₃, LiPON, and LiBON.

8. The thin film battery of claim 1, wherein the cathode current collector pattern comprises a nickel-containing alloy.

9. The thin film battery of claim 8, wherein the nickel-containing alloy comprises hastelloy or inconel.

10. The thin film battery of claim 1, wherein the anode current collector pattern comprises an alloy containing nickel or copper.

11. The thin film battery of claim 1, wherein molecular diffusion is performed in bonding portions of the bonded current collectors and terminals.

12. A method of directly bonding a cathode terminal and an anode terminal to a cathode current collector pattern and an anode current collector pattern of a thin film battery, respectively, without using a separate medium.

13. The method of claim 12, wherein the cathode terminal and the anode terminal are respectively bonded to the cathode current collector pattern and the anode current collector pattern of the thin film battery by inducing molecular diffusion in a bonded area or a local heat generation.

14. The method of claim 12, wherein bonding is performed according to at least one of ultrasonic processing, thermosonic processing, and micro-resistance heating processing.

15. A thin film battery, comprising:
a laminated body in which a plurality of unit cells are disposed in parallel, and each of the unit cells comprises a base substrate, a cathode current collector pattern and an anode current collector pattern being formed on the base substrate and being electrically separate from each other, a first cathode terminal and an first anode terminal being directly bonded with the cathode current collector pattern and the anode current collector pattern, a cathode and an anode being disposed on the cathode current collector pattern and the anode current collector pattern, and an electrolyte layer being disposed between the cathode and the anode; and
a sealing member sealing the laminated body.

16. The thin film battery of claim 15, wherein the sealing member comprises:
a first sealing member sealing a top of the laminated body; and
a second sealing member sealing a side and a bottom of the laminated body, and
an adjacent portion between the first sealing member and the second sealing member is welded by laser.

17. The thin film battery of claim 16, wherein the first sealing member comprises a glass member and a metal member.

18. The thin film battery of claim 15, further comprising:
a second cathode terminal electrically connecting the first cathode terminals to be externally exposed from the sealing member, and being formed of a single wire; and
a second anode terminal electrically connecting the first anode terminals to be externally exposed from the sealing member, and being formed of a single wire.
